(19) United States
(12) Patent Application Publication
(10) Pub. No.: US 2014/0282236 A1
(43) Pub. Date: Sep. 18, 2014

(54) ELECTRONIC DEVICE AND HUMAN-COMPUTER INTERACTION METHOD

(71) Applicant: HON HAI PRECISION INDUSTRY CO., LTD., New Taipei (TW)

(72) Inventors: WEN-CHIEH CHEN, New Taipei (TW); CHIN-SHUANG LIU, New Taipei (TW)

(73) Assignee: HON HAI PRECISION INDUSTRY CO., LTD., New Taipei (TW)

(21) Appl. No.: 14/192,862

(22) Filed: Feb. 27, 2014

(30) Foreign Application Priority Data
Mar. 15, 2013 (TW) 102109213

(51) Int. Cl. G06F 3/0488; G06F 3/06

(52) U.S. Cl. CPC G06F 3/0488; G06F 3/0604; G06F 3/0655; G06F 3/0671
USPC 715/806

(57) ABSTRACT

An electronic device includes an input/output (I/O) port and an instruction receiver located adjacent to the I/O port. When an external storage device is connected to the I/O port and the instruction receiver receives a predefined instruction input by a user, the electronic device generates a graphical user interface (GUI) to display a folder associated with the external storage device. A human-computer interaction method is also provided.

### REFERENCE TO RELATED APPLICATIONS

This application claims all benefits accruing under 35 U.S.C. §119 from Taiwan Patent Application No. 102109213, filed on Mar. 15, 2013 in the Taiwan Intellectual Property Office, entire contents of which are hereby incorporated by reference.

### BACKGROUND

1. Technical Field

The disclosure generally relates to electronic devices, and particularly relates to electronic devices having an input/out (I/O) port and human-computer interaction methods.

2. Description of Related Art

External storage devices (e.g., USB flash drives) are commonly used to store digital data between different computers. However, if a USB flash drive is connected to a computer, a user must perform multiple operations, such as operating multiple GUI elements, to open a folder associated with the USB flash drive. It may be inconvenient for the user to perform such operations.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a schematic view of an embodiment of an electronic device.

FIG. 2 is a partial view of the electronic device of FIG. 1.

FIG. 3 is a schematic view of another embodiment of an electronic device.

FIG. 4 is a block diagram of an embodiment of the electronic device.

FIG. 5 is a flowchart of an embodiment of a human-computer interaction method implemented by an electronic device.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

FIG. 1 is a schematic view of an embodiment of an electronic device 10. The electronic device 10 can be, but is not limited to, a notebook computer, a tablet computer, a gaming device, a DVD player, a radio, a television, a personal digital assistant (PDA), a smart phone, or any other type of portable or non-portable electronic device.

In one embodiment, the electronic device 10 includes a display member 20 rotatably coupled to a base member 30 to enable variable positioning of the display member 10 relative to the base member 30. A keyboard 33 and a touchpad 34 are located on a working surface 31 of the base member 30. In the illustrated embodiment, the touchpad 34 is adjacent to the keyboard 33.

An I/O port 35 is located on a lateral side surface 32 of the base member 30. The I/O port 35 may be a USB port, an eSATA port, a lightning port, or any other type of I/O port 35. An external storage device 50 may be connected to the I/O port 35. The external storage device 50 may be a flash drive, a removable hard disk drive, a SD memory card, or any other type of portable storage device. The lateral side surface 32 is substantially perpendicular to the working surface of the base member 30.

An instruction receiver 35 is located adjacent to the I/O port 35. The instruction receiver 35 includes a touch-sensitive surface for detecting touch instructions input by a user. When the external storage device 50 is connected to the I/O port 35 and the instruction receiver 35 receives a predefined touch instruction from the user, the electronic device 10 may generate a graphical user interface (GUI) to display a folder associated with the external storage device 50. The predefined touch instruction can include, for example, a double-click touch or a V-shaped slide touch.

In one embodiment, as shown in FIGS. 1 and 2, the touch-sensitive surface of the instruction receiver 36 is located on the working surface 31 of the base member 30 and adjacent to the I/O port 35. In another embodiment, as shown in FIG. 3, the touch-sensitive surface of the instruction receiver 36 is located on the lateral side surface 32 of the base member 30 and adjacent to the I/O port 35.

In some embodiments, the instruction receiver 36 includes a button. When the external storage device 50 is connected to the I/O port 35 and the button of the instruction receiver 35 is pressed by a user, the electronic device 10 may generate a GUI to display a folder associated with the external storage device 50. In some embodiments, the button of the instruction receiver 36 may be located on the working surface 31 or the lateral side surface 32 of the base member 30 and adjacent to the I/O port 35.

FIG. 4 shows a block diagram of an embodiment of the electronic device 10. The electronic device 10 further includes at least one processor 101, a suitable amount of memory 102, a display 103, and a control module 104. Of course, the electronic device 10 may include additional elements, components, modules, and be functionality configured to support various features that are unrelated to the subject matter described here. In practice, the elements of the electronic device 10 may be coupled together via a bus or any suitable interconnection architecture 105.

The processor 101 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here.

The memory 102 may be realized as RAM memory, flash memory, EPROM memory, EEPROM memory, registers, a hard disk, a removable disk, a CD-ROM, or any other form of storage medium known in the art. The memory 102 is coupled to the processor 101 such that the processor 101 can read information from, and write information to, the memory 102. The memory 102 can be used to store computer-executable instructions. The computer-executable instructions, when read and executed by the processor 101, cause the electronic device 10 to perform certain tasks, operations, functions, and processes described in more detail herein.

The display 103 is suitably configured to enable the electronic device 10 to render and display various screens, GUIs, GUI control elements, menus, texts, or images, for example. Of course, the display 103 may also be utilized for the display of other information during the operation of the electronic device 10, as is well understood. The display 103 can be located in the display member 20.

The control module 104 determines whether the instruction received by the instruction receiver 36 matches a predefined instruction. When the instruction matches the predefined instruction, the control module 104 may control the display 103 to generate a GUI to display a folder associated with the external storage device 50.

FIG. 5 shows a flowchart of one embodiment of a human-computer interaction method. The method includes the following steps.

In step S501, the external storage device 50 is connected to the I/O port 35.

In step S502, the instruction receiver 36 receives an instruction input by a user.

In step S503, the instruction receiver 36 determines whether the instruction matches a predefined instruction. If the instruction matches the predefined instruction, the flow proceeds to step S504. Otherwise, the flow ends.

In step S504, the electronic device 10 may generate a GUI to display a folder associated with the external storage device 50.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

What is claimed is:

1. An electronic device, comprising:
an input/output (I/O) port configured for connecting to an external storage device;
an instruction receiver located adjacent to the I/O port and configured for receiving an instruction;
a control module configured for determining whether the instruction matches a predefined instruction; and
a display configured for generating a graphical user interface (GUI) to display a folder associated with the external storage device when the instruction matches the predefined instruction.

2. The electronic device of claim 1, further comprising a base member and a display member rotatably coupled to the base member, wherein the base member comprises a working surface and a lateral side surface substantially perpendicular to the working surface, the I/O port is located on the lateral side surface.

3. The electronic device of claim 2, wherein the instruction receiver comprises a touch-sensitive surface configured for receiving a touch instruction, the control module is configured for determining whether the touch instruction matches a predefined touch instruction, and when the touch instruction matches the predefined touch instruction, the display is configured for generating the GUI to display the folder associated with the external storage device.

4. The electronic device of claim 3, wherein the touch-sensitive surface of the instruction receiver is located on the working surface of base member and adjacent to the I/O port.

5. The electronic device of claim 3, wherein the touch-sensitive surface of the instruction receiver is located on the lateral side surface of base member and adjacent to the I/O port.

6. The electronic device of claim 3, wherein the predefined touch instruction comprises a double-click touch.

7. The electronic device of claim 3, wherein the predefined touch instruction comprises a V-shaped slide gesture.

8. The electronic device of claim 2, wherein the instruction receiver comprises a button, the control module is configured for determining whether the button is pressed, and when the button is pressed, the display is configured for generating the GUI to display the folder associated with the external storage device.

9. The electronic device of claim 8, wherein the button of the instruction receiver is located on the working surface of base member and adjacent to the I/O port.

10. The electronic device of claim 8, wherein the button of the instruction receiver is located on the lateral side surface of base member and adjacent to the I/O port.

11. A human-computer interaction method implemented in an electronic device comprising:
detecting an external storage device is being attached to the electronic device via an I/O port of the electronic device;
detecting an instruction;
determining whether the instruction matches a predefined instruction; and
generating a GUI displaying a folder associated with the external storage device when the instruction matches the predefined instruction.

12. The human-computer interaction method of claim 11 comprising:
detecting the instruction input via a touch sensitive surface.

13. The human-computer interaction method of claim 12, wherein the predefined instruction comprises a double-click touch.

14. The human-computer interaction method of claim 12, wherein the predefined instruction comprises a V-shaped slide gesture.

15. The human-computer interaction method of claim 11 comprising:
detecting the instruction input via a button; and
generating the GUI displaying the folder associated with the external storage device when detecting the button being pressed.
